(19) United States
(12) Patent Application Publication
(10) Pub. No.: US 2025/0329133 A1
(43) Pub. Date: Oct. 23, 2025

(54) SYSTEM AND METHOD FOR LOCATION BASED IMAGE ANALYSIS

(71) Applicant: ZIGNAL LABS, Inc., San Francisco, CA (US)

(72) Inventors: Zeyad Hailat, Canton, MI (US); Andras Benke, Bellevue, WA (US); Joanna Esther Vasquez, Alexandria, VA (US); Balachandra R. Deshpande, Northville, MI (US); Sunny Bhaveen Chandra, Karnataka (IN); Vudata Geet Sameer, Andhra Pradesh (IN); Alexander T. Parsons Smith, Rushville, NE (US)

(21) Appl. No.: 19/063,376

(22) Filed: Feb. 26, 2025

Related U.S. Application Data
(60) Provisional application No. 63/557,610, filed on Feb. 26, 2024.

(51) Int. Cl. G06V 10/74; G06V 10/25; G06V 10/40; G06V 10/72; G06V 10/774; G06V 20/70; G06V 40/10

(52) U.S. Cl. CPC G06V 10/761; G06V 10/25; G06V 10/40; G06V 10/72; G06V 10/774; G06V 20/70; G06V 40/10; G06V 2201/08

(57) ABSTRACT

A system and method for analyzing an image to identify features associated with a particular location or locations.

### FIELD OF THE INVENTION

The present disclosure relates to the analysis of images based on location and, more particularly to, analysis of images to identify features associated with a particular location or locations.

### BACKGROUND OF THE INVENTION

“PIGEON: Predicting Image Geolocations” (Haas, L., Skreta, M., Alberti, S., & Finn, C. (2023). PIGEON: Predicting Image Geolocations. arXiv preprint arXiv:2307.05845) focuses on a novel system for planet-scale image geolocalization. This system integrates techniques like semantic geocell creation, multi-task contrastive pretraining, and a unique loss function. It utilizes two models: PIGEON, trained on Street View data, and PIGEOTTO, trained on diverse images from Flickr and Wikipedia. Both models are focused on geolocating images by continent, region and country.

U.S. Pat. No. 10,699,398, held by Uber Technologies, details a system for improving the accuracy of coordinate prediction using computer-implemented methods. The patent describes a process where a deep learning model is trained on a dataset comprising satellite images and service data, including pick-up and drop-off data, for places whose geographical locations are already known. This trained model is then utilized to predict the geographical location of other places for which the location is unknown.

Predicted geographical locations are stored in a database and are associated with the identification of respective places. These locations can be retrieved and used upon receiving service requests related to these places. The deep learning model is trained on integrated data, combining satellite imagery with service data. It is capable of generating a predicted location based on this composite data for places not included in the initial training set.

### SUMMARY

The background art does not teach or suggest a system or method for analyzing images to determine similarity or association, without additional geolocation data or other forms of data.

The present invention, in at least some embodiments, relates to a system and method for analyzing an image to identify features associated with a particular location or locations, thereby overcoming the background art.

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure. The terms “information”, “stories”, “content” and “media content” may be used interchangeably herein. Further, the terms “customer”, “user” and “audience” may be used interchangeably herein. Furthermore, the terms “topic” and “theme” may be used interchangeably herein.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions-which can be a set of instructions, an application, software-which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. The drawings referred to in this description are not to be understood as being drawn to scale except if specifically noted, and such drawings are only exemplary in nature.

In the drawings:

FIG. 1 shows a non-limiting, illustrative example of a system for location based image analysis, according to at least some embodiments;

FIGS. 2A and 2B show non-limiting, illustrative examples of methods for location based image analysis, according to at least some embodiments;

FIG. 3 shows a non-limiting, illustrative example of a method for performing an ANN (artificial neural network) algorithm according to at least some embodiments;

FIGS. 4A-4E show non-limiting, illustrative examples of results obtained from applying the system and methods herein;

FIGS. 5A and 5B show non-limiting, illustrative example of methods for data preparation and model training for determining a location for an image according to at least some embodiments;

FIG. 6A shows non-limiting, exemplary Approximate Nearest Neighbor (ANN) Search Results, with 2048 features;

FIG. 6B shows a summary of some non-limiting, exemplary Approximate Nearest Neighbor (ANN) Search Results;

FIG. 7 shows a non-limiting, exemplary autoencoder architecture;

FIG. 8 shows the results of combined processing through the autoencoder and through CLIP;

FIGS. 9A and 9B relate to non-limiting, exemplary methods for performing the above analysis on objects;

FIG. 10 shows an optional pre-processing method for images according to at least some embodiments;

FIG. 11A shows an example of the pre-processing method for images;

FIG. 11B shows an optional method for training with processed images; according to at least some embodiments;

FIG. 12A shows an illustrative image before processing;

FIG. 12B shows the image after processing;

FIGS. 13A-16B show pairs of images before processing (FIGS. 13A, 14A, 15A and 16A) and after processing (FIGS. 13B, 14B, 15B and 16B); and

FIGS. 17A and 17B show illustrative errors caused by incorrect prompt engineering.

### DETAILED DESCRIPTION

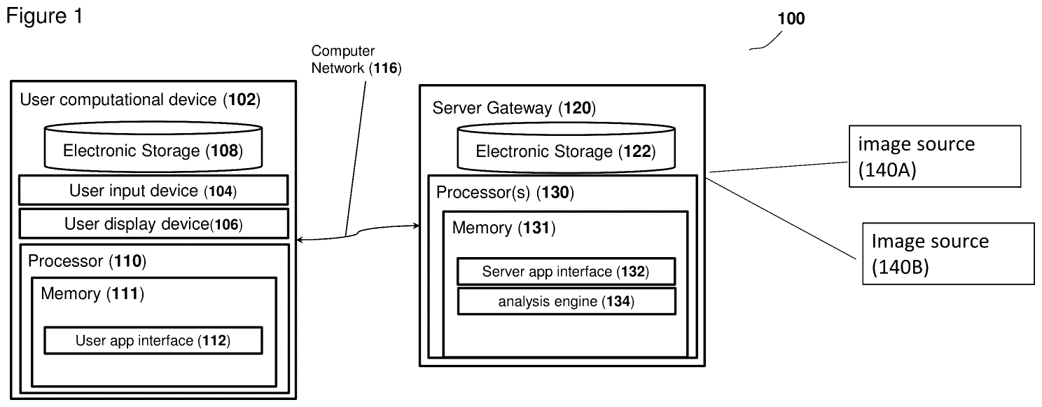

FIG. 1 shows a non-limiting, illustrative example of a system for location based image analysis, according to at least some embodiments. As shown in a system 100, a user computational device 102 communicates with a server gateway 120 through a computer network 116. Server gateway 120 in turn communicates with one or more additional servers, for example to access one or more image sources 140A and 140B.

Server gateway 120 preferably comprises an analysis engine 134 for analyzing one or more image source(s) 140A and 140B, preferably in real time, to determine the location of an image. The location may be determined as an absolute identity (for example, the Eiffel Tower) or as a relative identity (for example, a plurality of images may be determined to show the same or at least similar location). For example, analysis engine 134 may analyze each image from image source(s) 140A and 140B according to one or more location identification models as described herein. For example, the location identification model may comprise an ANN, a CLIP analysis or other suitable model. The location identification model may also be trained or retrained according to the analysis.

Through user computational device 102, the user may determine which image analysis model(s) and/or image source(s) 140A and 140B are relevant for analysis through a user interface 112. The user may also select one or more images for review according to such application of a location identification model through user interface 112.

User computational device 102 preferably includes the user input device 104, and user display device 106. The user input device 104 may optionally be any type of suitable input device including but not limited to a keyboard, microphone, mouse, or other pointing device and the like. Preferably user input device 104 includes one or more of a microphone and a keyboard, mouse, or keyboard mouse combination.

User computational device 102 also comprises a processor 110 and a memory 111.

Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 111 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for receiving information from the user through user app interface 112 and a second set of machine codes selected from the native instruction set for transmitting such information to server gateway 120 in regard to one or more commands for analyzing images, for example according to one or more location identification models and/or one or more image sources.

Similarly, server gateway 120 preferably comprises processor 130 and memory 131 with machine readable instructions with related or at least similar functions, including without limitation functions of server gateway 120 as described herein. For example and without limitation, memory 131 may store a first set of machine codes selected from the native instruction set for receiving image analysis model(s) from an image analysis model source (not shown), a second set of machine codes selected from the native instruction set for receiving images from one or more image source(s) 140A and 140B, and a third set of machine codes selected from the native instruction set for executing functions of analysis engine 134.

User computational device 102 preferably comprises an electronic storage 108 for storing data and other information. Similarly, server gateway 120 preferably comprises an electronic storage 122.

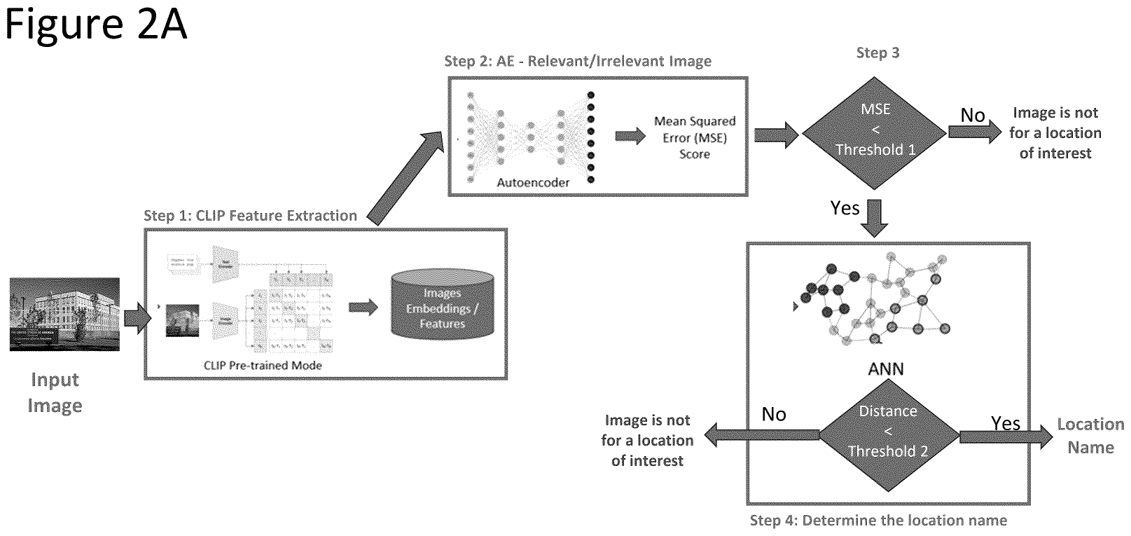

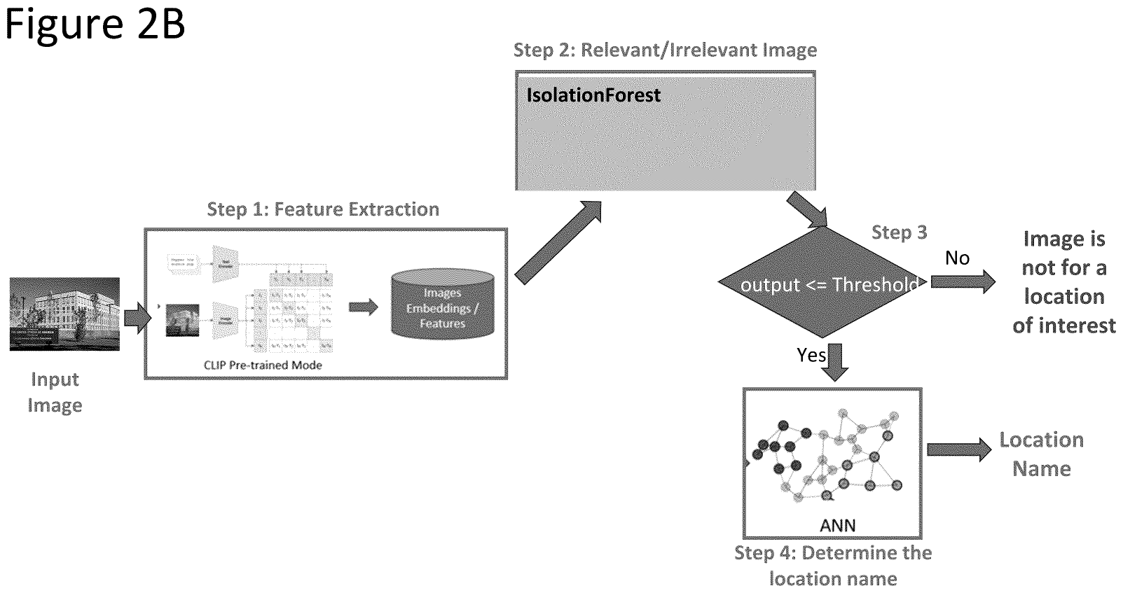

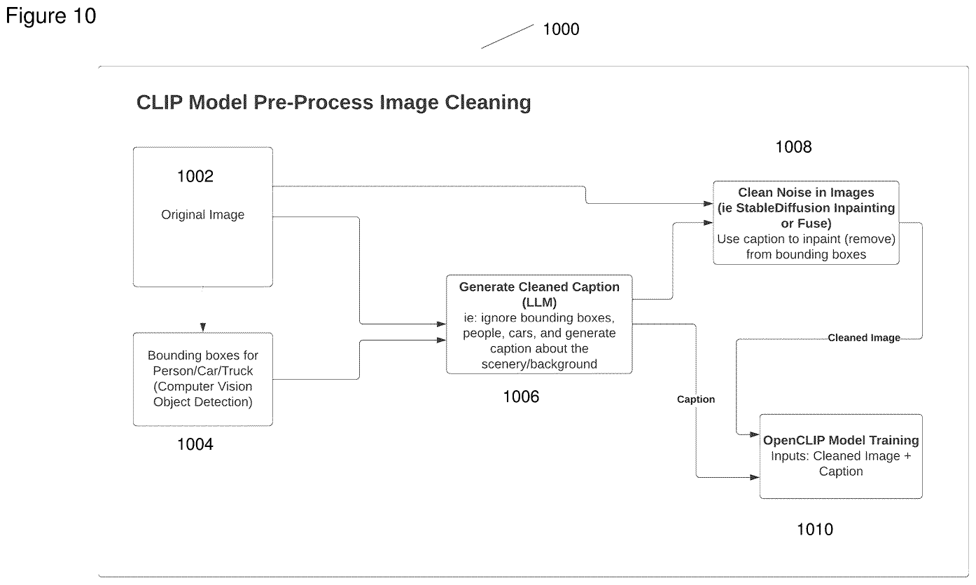

FIGS. 2A and 2B show non-limiting, illustrative examples of methods for location based image analysis, according to at least some embodiments. As shown in FIG. 2A, an image for which the location is to be identified, is input to a CLIP Feature Extraction in step 1. The image may be processed as described with regard to FIGS. 10-17B. Preferably, according to at least some embodiments, this CLIP model may be previously trained using a corpus of cleaned images that have been processed through the cleaning pipeline described with regard to FIGS. 10-17B.

The CLIP Feature Extraction preferably includes a CLIP pretrained model, which is able to construct image embeddings. CLIP (Contrastive Language-Image Pre-training) is an OpenAI-developed model that grasps representations by harmonizing images with their descriptions within a unified embedding space (Radford, A et al (2021 July). Learning transferable visual models from natural language supervision; In International conference on machine learning (pp. 8748-8763). PMLR). The training process may include: harvesting and cleaning geotagged images, incorporating the cleaned images and their corresponding captions into the CLIP corpus, and training the CLIP model using this dataset of cleaned geotagged images. The CLIP model may be used to generate condensed image embeddings, capturing essential image features in a compact format smaller than the original image. These embeddings are structured as a vector comprising 512 numerical values.

Without wishing to be limited by a closed list, CLIP may be used to understand both textual descriptions and images, enabling it to establish connections between them within a shared embedding space. However, the method as described is not reliant upon this capability; instead, other models may be used to construct the image embeddings. Non-limiting examples of models for image embeddings include ResNet (for example and without limitation, variants like ResNet-50, ResNet-101, etc.; convolutional neural networks (CNNs)); VGG (Visual Geometry Group) model variants, such as VGG16 or VGG19, may provide image embeddings; EfficientNet models offer a balance between accuracy and computational resources for generating image embeddings and may be used; or ViT (Vision Transformer), which uses transformer architectures for image processing, breaking images into patches and processing them similarly to text data.

In step 2, the image is fed to an autoencoder, which determines whether the image is relevant or irrelevant, based on the MSE (mean squared error) score. Autoencoders are neural network models that learn to encode data into a lower-dimensional representation and then decode it back to the original form. The MSE of the image under analysis is determined by comparing its embeddings (from the CLIP model or another model) to those of the images on which the autoencoder was trained. Anomalies are detected based on reconstruction error by the autoencoder, with higher errors indicating potential anomalies. In this case, lower errors are preferred.

In step 3, if the MSE is above a first threshold, then the error is too high and the image is not of interest. However, if it is below the threshold, then the image is of interest and proceeds to the next step. In step 4, the image is compared to other images for which an absolute location is known or for which a relative location is of interest. This comparison may be performed through a suitable image comparison model, such as an ANN. If the distance or other comparison output of the model is below a threshold, such that the comparison output is defined to indicate greater relevance with lower values, then the image is relevant as being related to a location of interest and is matched to that location. Otherwise the image is determined as not being of a location of interest.

The Approximate Nearest Neighbor (ANN) algorithm is a method used to efficiently find approximate closest matches or nearest neighbors to a given query point in a dataset, especially in high-dimensional spaces. It sacrifices accuracy for speed, aiming to retrieve “close enough” neighbors rather than the exact nearest ones.

In high-dimensional spaces, exhaustive nearest neighbor search becomes computationally expensive. ANN methods provide a trade-off by offering fast retrieval of neighbors with reasonably close proximity to the query point, even if they're not the absolute nearest. ANN algorithms are widely used in various fields like machine learning, computer vision, information retrieval, recommendation systems, and data mining. ANN models are suitable for tasks involving similarity search, clustering, and classification.

The same embeddings that are output from step 1 may be analyzed by the ANN model as described herein. Optionally, other distance measurements may be used for determining proximity of two or more images (and hence similarity). Preferably, the ANN analysis features a second threshold to reduce false positives, after the ANN comparison has been performed to determine the distance between the image under analysis and images on which the ANN model has been trained. Preferably, such a distance is lower than the second threshold.

Without wishing to be limited by a closed list, this process as described implements a two-stage filtering approach: first determining if an image contains relevant location features (through the autoencoder), then identifying specific location matches (through the ANN), helping to ensure accurate location identification while efficiently handling irrelevant images.

FIG. 2B shows another method, similar to that of FIG. 2A, but now featuring an IsolationForest algorithm for step 2, in place of the previously described autoencoder. In step 3, if the output of the IsolationForest algorithm is above a certain threshold, then the image is considered to be of interest and proceeds to step 4. Otherwise, the image is rejected. Isolation Forest is an anomaly detection algorithm used in machine learning for identifying outliers/anomalies in a dataset (Fei Tony Liu, Kai Ming Ting, and Zhi-Hua Zhou, “Isolation Forest”, IEEE International Conference on Data Mining 2008 (ICDM 08)). The algorithm works by isolating anomalies more effectively than normal data points, utilizing decision trees. It constructs a set of decision trees, each randomly selecting a feature and then splitting the data until the anomalies are isolated into smaller partitions with fewer splits. Anomalies, being isolated more quickly, require fewer splits in the trees. Thus, they have shorter average path lengths compared to normal points. By measuring the average path length, anomalies can be identified. Without wishing to be limited by a closed list, Isolation Forest is effective with high-dimensional data, is less sensitive to outliers, and tends to perform well even with a smaller dataset.

Other non-limiting examples of suitable algorithms for anomaly detection include One-Class SVM (Support Vector Machine), Local Outlier Factor (LOF); DBSCAN (Density-Based Spatial Clustering of Applications with Noise); and K-Means Clustering. One-Class SVM is a method of training a classifier only on the normal data points, aiming to create a boundary around them. Any data point falling outside this boundary is considered an anomaly. LOF identifies outliers by comparing the density of points in the vicinity of a particular data point to the density of its neighbors. Points with significantly lower densities are labeled as outliers.

DBSCAN is a clustering algorithm that identifies outliers as points lying in regions of low data density. It groups together points that are closely packed, labeling points in sparser regions as anomalies. K-Means can be used for anomaly detection by assigning points to clusters. Points lying far from the cluster centers or belonging to clusters with a small number of points might be considered anomalies.

In step 4, the location name is determined, optionally as described with regard to FIG. 2A, in terms of applying a second threshold; but alternatively without such a second threshold.

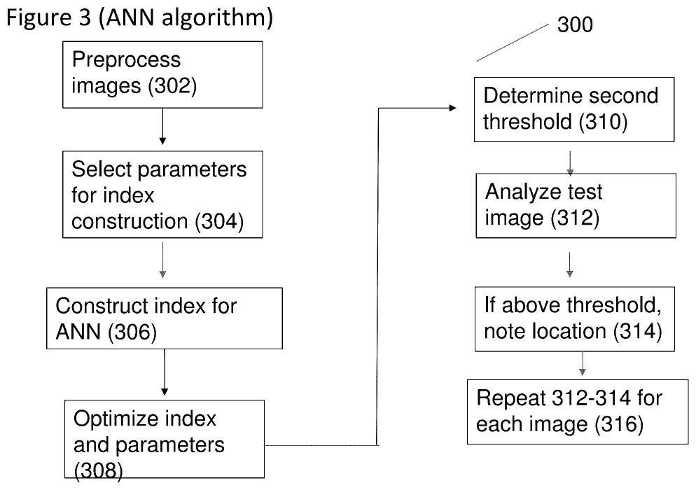

FIG. 3 shows a non-limiting, illustrative example of a method for performing an ANN algorithm according to at least some embodiments. The ANN model is not trained as for a deep learning model for example; instead, data is used to create an index, against which an image of interest may be compared to determine similarity. In a method 300, at stage 302, the desired parameters are selected for index construction. These parameters depend on the method used for index construction and are described in greater detail below.

At stage 304, the dataset of interest is preprocessed, containing the images of interest. For example, preprocessing may include constructing embeddings as previously described, for example through a pretrained CLIP model. At stage 304, the index is created from these embeddings. Various methods, including but not limited to trees (K-D trees, ball trees), hashing (Locality-Sensitive Hashing or LSH), or graph-based techniques (Navigable Small World graphs, including for example Hierarchical Navigable Small World (HNSW) graphs) may be used to create this index. The choice of method depends on the nature of the data and the dimensionality.

The parameters selected depend upon the method used to create the index. For example and without limitation, such parameters might include the number of trees in a forest, the width of buckets in hashing, or the number of neighbors to consider in graph-based methods.

In stage 308, the parameters and the indexing method may be optimized for better performance. Optionally, this stage is performed before the index is constructed, or as part of a loop that may be repeated at least once for better performance. Non-limiting examples of optimization parameters include balancing between the speed of the query, the accuracy of the results, and the memory usage.

In use, at stage 310, the second threshold value is preferably determined, according to the distance output from the ANN model. The similarity between two images for the comparison step is then measured by calculating the angular distance between their normalized feature vectors. The angular distance represents the angle between the two vectors in high dimensional space. Mathematically, the angular distance θ is calculated as: θ=cos−1(A·B)
where A and B are the normalized feature vectors for image A and image B, and · represents the dot product between the vectors.

The more similar each pair of images are in content and features, the smaller the angle between their vectors meaning they have a smaller angular distance. Dissimilar images lead to larger angular distances.

Next a test image is compared at stage 312.

If the comparison is above a threshold, such that the angular distance is sufficiently small, then the location is noted at 314, for example because the location is of interest, and/or because it matches a known location and/or because it matches a relative location from another image. Stages 312-314 are then repeated for each image or pair of images, at 316.

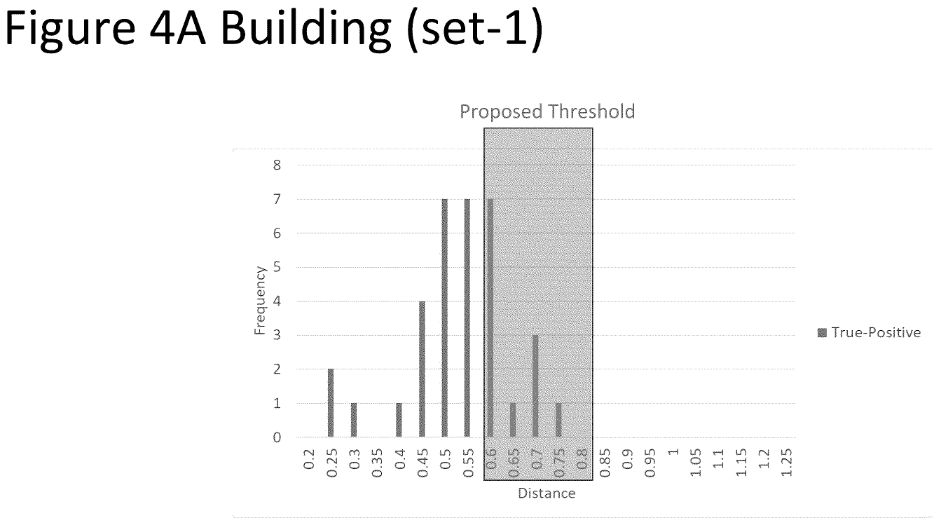

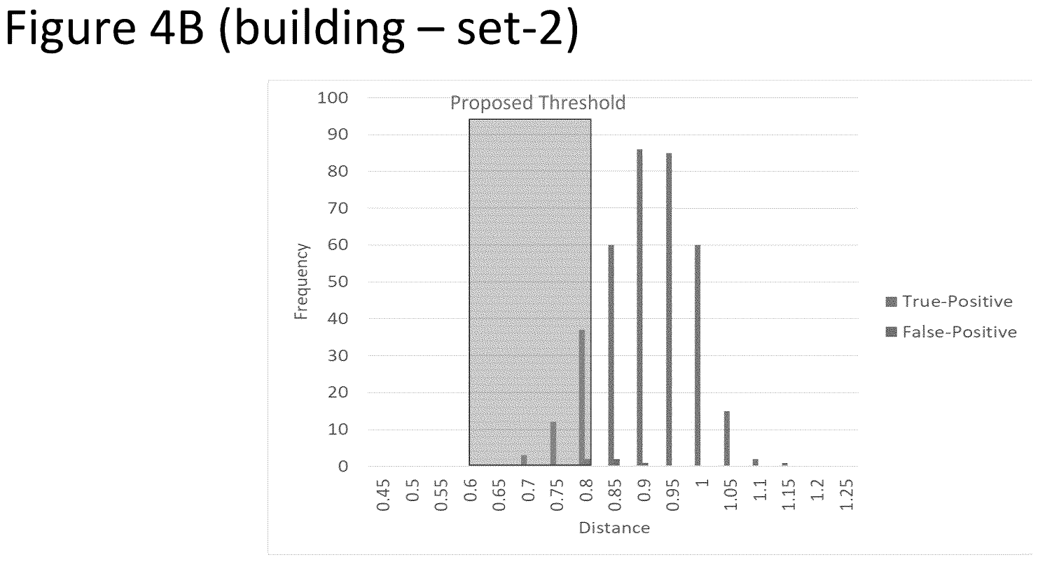

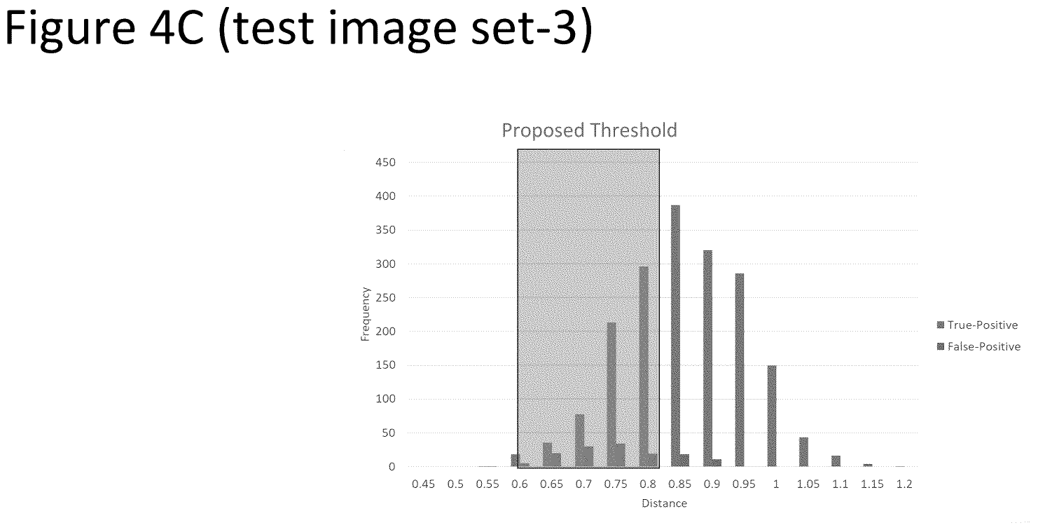

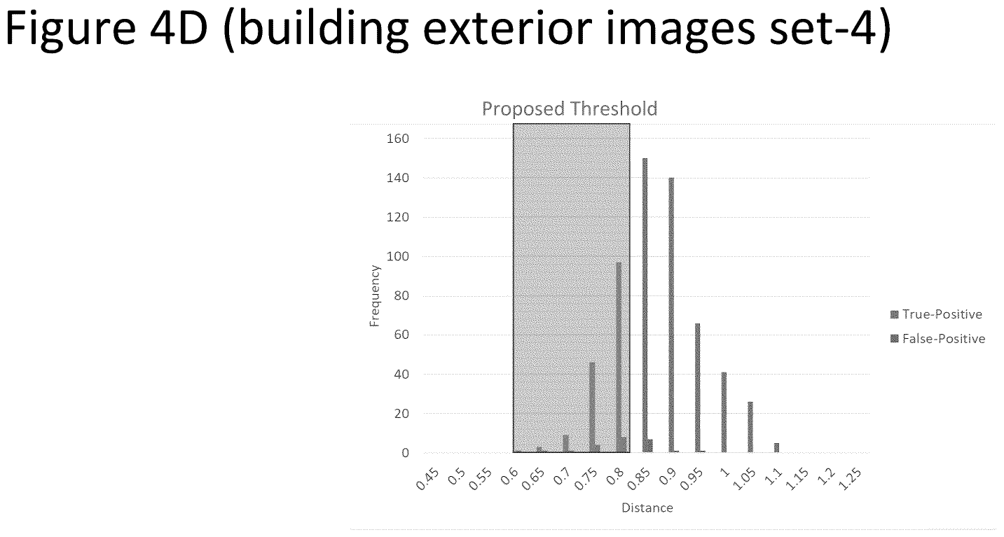

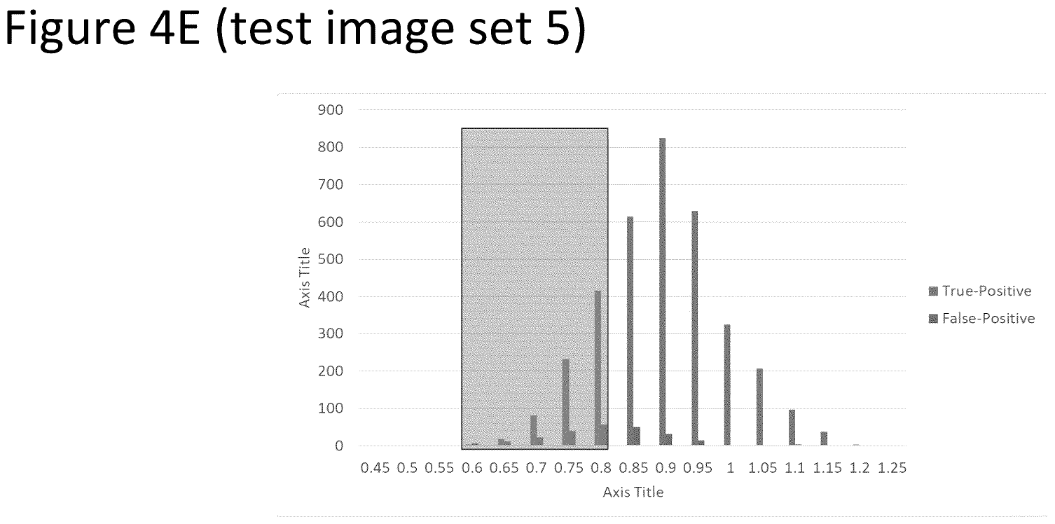

FIGS. 4A-4E show non-limiting, illustrative examples of results obtained from applying the system and methods herein. For these Figures, distance (y-axis) shows the cosine similarity, while frequency is the count of images that fall into that distance measurement. The distance was determined according to the ANN model as previously described. The threshold range shown was used to assist in developing appropriate values for the second threshold (threshold 2) as described above. The threshold was calculated across multiple use cases for different test datasets, in regard to sensitivity vs accuracy. FIGS. 4B-4E include an additional factor, true positives and false positives. False positives were located through manual labelling of images that were not positive, but were considered to be relevant by the autoencoder, such that they underwent the ANN model analysis.

FIG. 4A shows the results from analyzing a set of building images, referred to as set-1. FIG. 4B shows such results from analyzing set-2 of building images. FIG. 4C shows such results from analyzing set-3 of additional location images. FIG. 4D shows such results from analyzing set-4 of building exterior images. FIG. 4E shows such results from analyzing set-5 of additional location images.

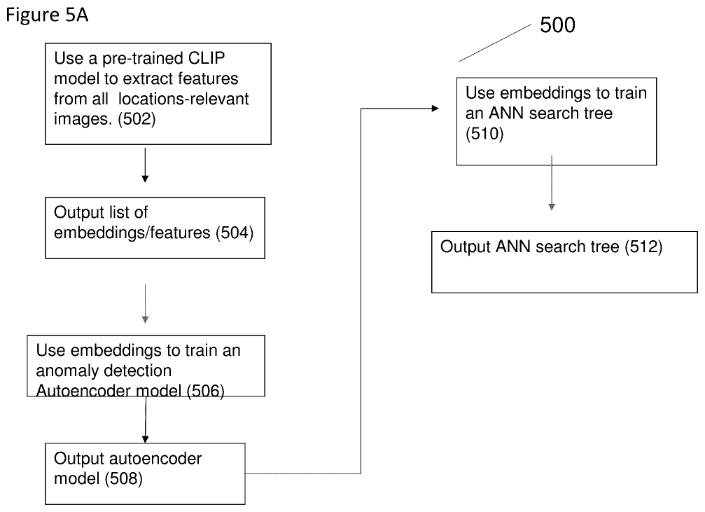

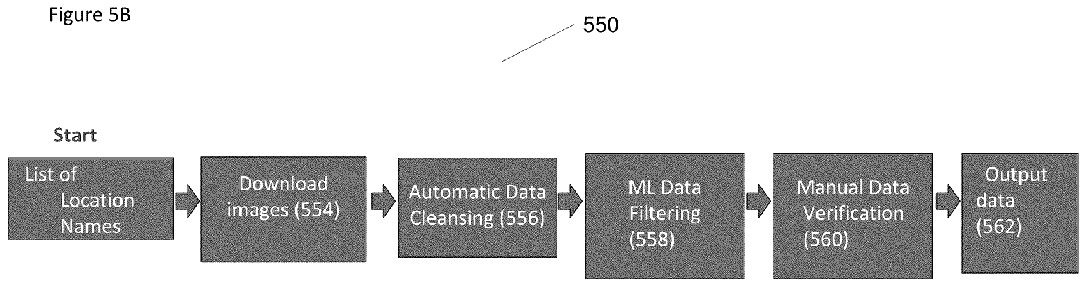

FIGS. 5A and 5B show non-limiting, illustrative examples of methods for data preparation and model training for determining a location for an image according to at least some embodiments. Turning now to FIG. 5A, as shown in a method 500, at 502, a pre-trained CLIP model is used to extract features from location-relevant images. These are images which may be from a similar or identical location, and/or may be suspected of being from a related or at least relevant location. At 504, a list of features and embeddings is output. At 506, the embeddings are used to train an anomaly detection Autoencoder model, as described above.

At 508, the autoencoder model is output. For such a model, underfitting or overfitting are greater concerns rather than local minima; the autoencoder model is tested to prevent such underfitting or overfitting. At 510, the embeddings are used to create the indexes for an ANN search tree model as previously described. At 512, the indexes of the ANN search tree model are output.

FIG. 5B shows a non-limiting, exemplary data preprocessing flow, for obtaining data for training and testing the system as described herein. As shown in a method 550, the method begins at 552, when a list of location names is provided in text form. Next, images related to the location names are obtained, whether through a search engine, an image engine, an image database, or some combination thereof, at 554.

Automatic data cleansing is then performed at 556. For example and without limitation, such data cleaning may comprise one or more of the following actions: exclude duplicated images; recognize and exclude grayscale images; recognize and exclude blurry images; and/or recognize and exclude images according to dimension size and/or size on disk.

By image dimension size, it is meant that images are preferably excluded if at least one dimension is less than 150 pixels, or some other suitable threshold size. By size on disk, it is meant that images are recognized and excluded if the size of the image as stored in a memory is less than a threshold, which for example may be 50 KB.

At 558, ML data filtering is preferably performed, with a machine learning algorithm or another suitable model. Manual data checking and verification is preferably performed at 560, to confirm the quality and validity of the filtered images. At 562, the data is output, and may be used for model training purposes, model testing purposes, and so forth.

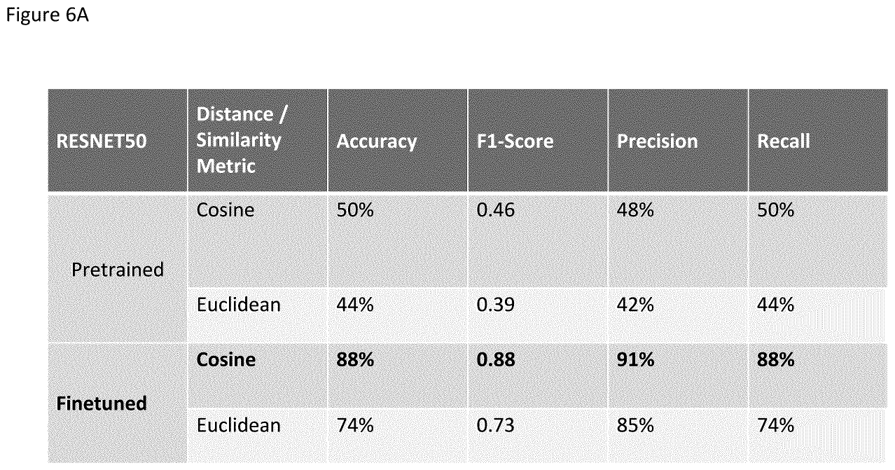

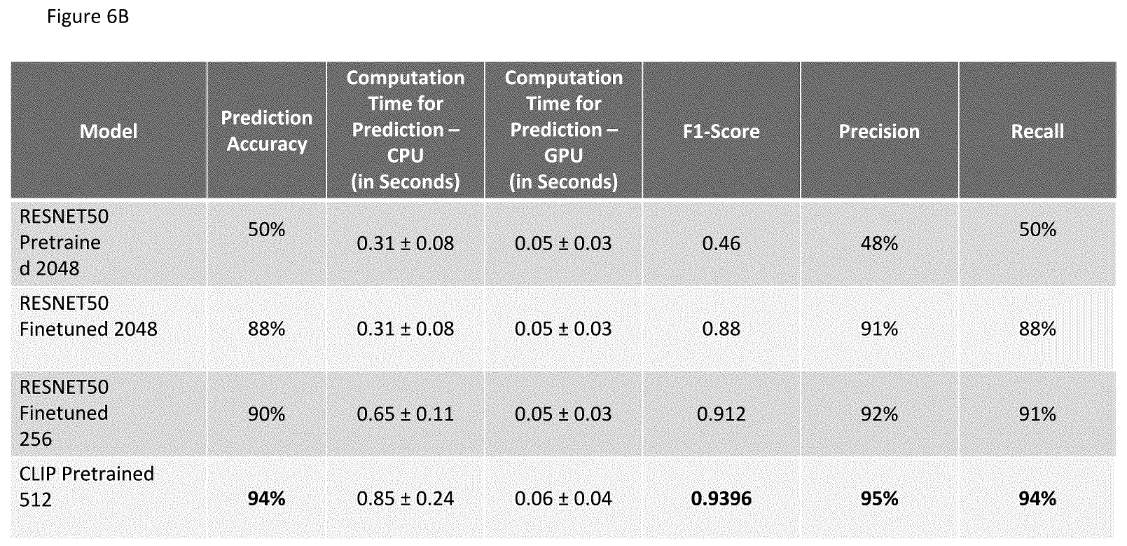

FIG. 6A shows non-limiting, exemplary Approximate Nearest Neighbor (ANN) Search Results, with 2048 features, using a test set of images. The features were extracted in this example with ResNet50. The image embeddings were provided by ResNet50 as previously described. The ResNet50 model was either pretrained, or else fine tune training was performed first. Two different distance measurements were used for the second threshold for the ANN model: Cosine and Euclidean. The results show that the ResNet50 model improved considerably with fine tune training. Furthermore, the Cosine distance measurement for the ANN model also improved its results.

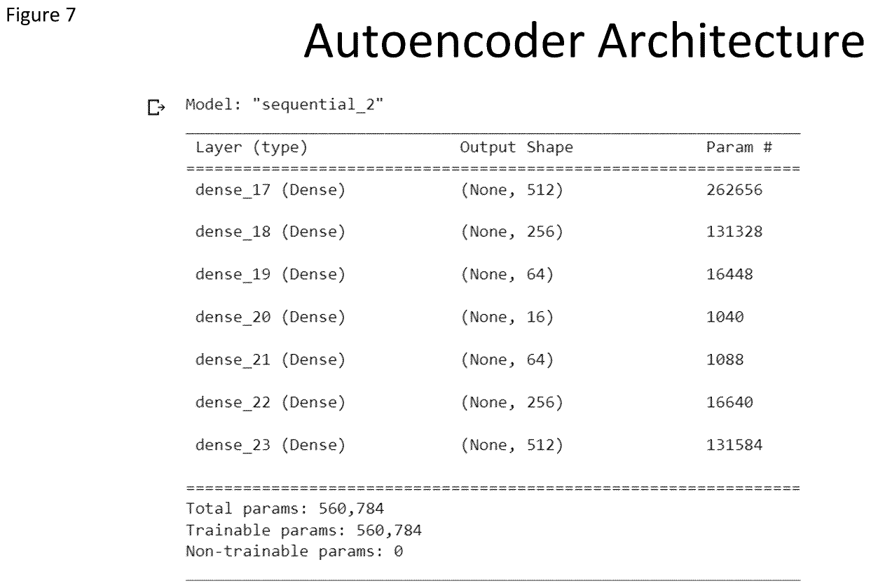

FIG. 6B shows a summary of some non-limiting, exemplary Approximate Nearest Neighbor (ANN) Search Results, according to the model that was used to produce the embeddings. The same distance measurement for the second threshold for the ANN model was used in all cases. Briefly, embeddings from the CLIP pretrained model provided the best results. FIG. 7 shows a non-limiting, exemplary autoencoder architecture.

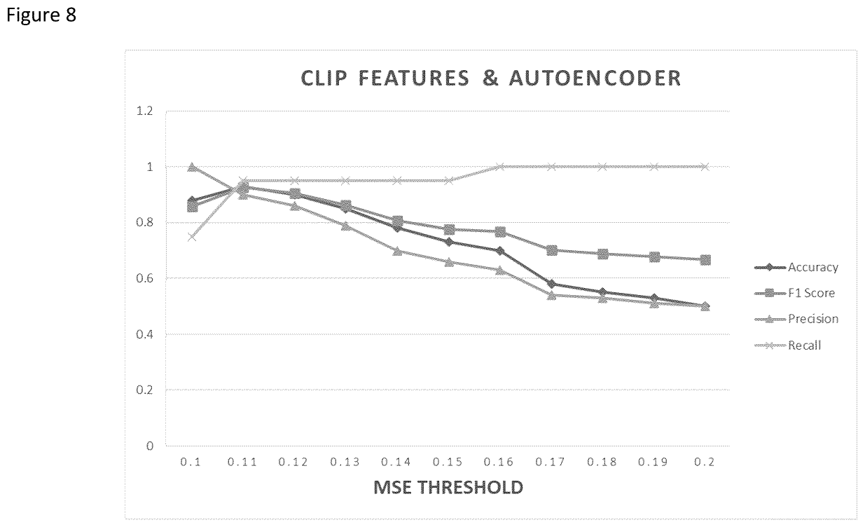

FIG. 8 shows the results of combined processing through the autoencoder and through CLIP.

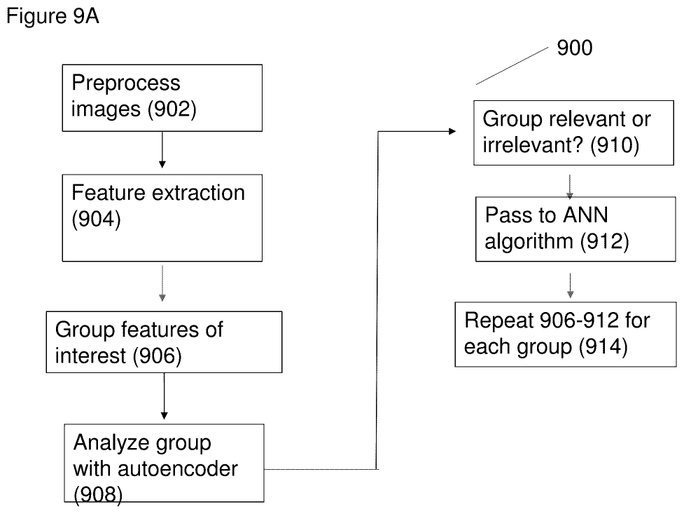

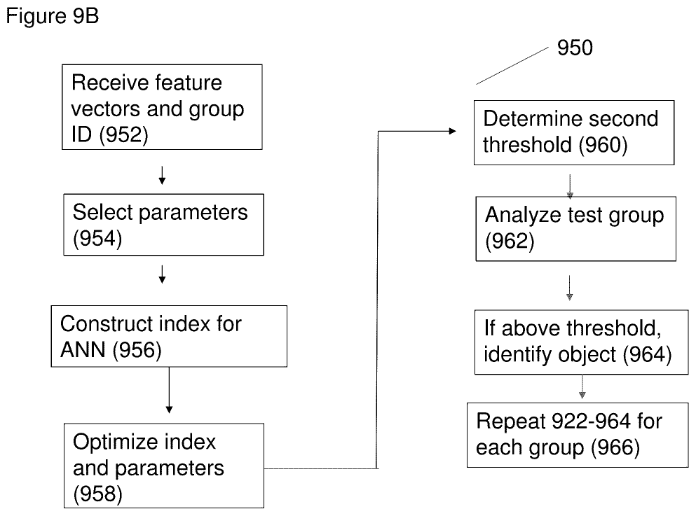

FIGS. 9A and 9B relate to non-limiting, exemplary methods for performing the above analysis on objects. Turning first to FIG. 9A, a non-limiting exemplary method is shown for performing the above described methods for generating image embeddings and then applying an autoencoder, but for objects within images, rather than for a single image.

As shown in a method 900, the method begins with the preprocessing of images at 902, which involves preparing the images for further analysis by performing various operations such as resizing, normalization, or color correction.

Following preprocessing, feature extraction is performed at 904. This step involves identifying and extracting salient features from the images that are relevant, to form embeddings

Once the features have been extracted, they are grouped based on their characteristics or relevance to particular aspects of the analysis at 906.

The grouped features are then analyzed using an autoencoder at 908, for example as previously described.

After the analysis, the groups of features are classified as either relevant or irrelevant based on the criteria established by the autoencoder's output at 910. For example, if the MSE or other distance measurement is not below a first threshold, then the groups of features are classified as irrelevant. Only relevant groups of features continue in the process.

Finally, the relevant groups of features are passed to a specific algorithm designed for further analysis or decision-making processes, such as the previously described ANN algorithm, at 912. This process may be repeated at 914, for each group of features.

Turning now to FIG. 9B, a method is shown for analyzing the relevant groups of features with the previously described ANN algorithm. A method 950 begins by receiving a group of feature vectors along with their corresponding group ID, at 952. This collection serves as the input data for the subsequent steps.

Next, parameters for the Approximate Nearest Neighbor (ANN) algorithm are selected at 954. These parameters are pivotal in determining the performance and accuracy of the ANN algorithm.

With the parameters in place, an index for the ANN algorithm is constructed at 956. This index is a data structure that facilitates efficient nearest neighbor searches within the feature vectors.

Following the construction of the index, both the index and the selected parameters undergo optimization at 958. This optimization process is aimed at enhancing the search efficiency and accuracy of the ANN algorithm.

Subsequently, a second threshold is determined at 960. This threshold is used to discern relevant outputs from the ANN algorithm, which indicates a successful identification of similar feature vectors.

The method proceeds to analyze a test group of features using the optimized ANN algorithm and the established threshold at 962. If the analysis results in an output that is above the threshold, the object represented by the test group of features is identified as relevant or of interest at 964.

This process, starting from receiving the group of feature vectors to identifying the object, is preferably repeated for each group to ensure comprehensive analysis, at 966.

Optionally, a location as previously described, or an object as described herein, may be added to a vocabulary of locations or images. For example, a vocabulary of particular buildings or other locations may involve multiple images of the particular buildings or other locations from different angles or orientations, which may be collectively grouped for easier identification. Similarly, a vocabulary of one or more objects may involve multiple images of the one or more objects from different angles or orientations, which may be collectively grouped for easier identification.

FIGS. 10-17B relate to non-limiting, exemplary methods for removing undesired objects from an image, such as transient objects for example, before training an AI model with the image, as well as exemplary before and after images. These figures demonstrate an inventive, exemplary solution to the problem of object misclassification and feature bias within AI model training data, for example for use within a CLIP (Contrastive Language-Image Pre-training) model.

The CLIP model was developed by OpenAI and comprises a dual-encoder architecture, for processing and relating visual and textual data. The model features two main components: an image encoder and a text encoder.

The image encoder may optionally comprise a convolutional neural network (CNN) or a vision transformer. The text encoder preferably comprises a transformer model. Both encoders map their respective inputs (images and text) into a shared embedding space, enabling direct comparisons between these different types of data.

The model employs contrastive learning to train the encoders. In this approach, the model is trained to maximize similarity scores between matching image-text pairs while minimizing similarity scores between non-matching pairs. This training methodology enables the model to generate robust embeddings that capture semantic relationships between images and text.

Without wishing to be limited by a closed list, the model may be trained on a large dataset, for example comprising approximately 400 million image-text pairs. This extensive training dataset enables the model to learn relationships between a wide variety of visual concepts and their textual descriptions.

Again without wishing to be limited by a closed list, the model features several advantageous characteristics. For example, the model demonstrates zero-shot learning capabilities, meaning it can perform various image classification tasks using only natural language descriptions, without requiring additional training. The model also demonstrates flexibility in application, being suitable for tasks including but not limited to object classification, action recognition, and optical character recognition (OCR).

The model's training approach demonstrates improved efficiency compared to conventional approaches, reducing requirements for task-specific labeled datasets. Furthermore, the model's ability to process and relate both images and text enables advanced applications including but not limited to image retrieval, content moderation, and various creative applications.

Of course, various types of models may be implemented with the present invention, in addition to or as a replacement for the CLIP model. Any such model according to at least some embodiments may optionally be modified to incorporate additional types of data, such as audio data or depth information, extending its multimodal capabilities beyond text and images.

As an illustrative, non-limiting example, when collecting images from sources such as social media that are classified as “outdoors” for use in a specific geographic CLIP model, such as a specific city-wide model, many images contain elements that could bias or confuse the model. For example, many social media photos contain selfies, vehicles, or other common objects in the foreground that obscure or compete with the valuable permanent features (such as buildings, trees, city skylines) that should be used for location identification.

This issue becomes particularly apparent when training a model with non-cleaned data containing a large number of images (for example, approximately 100,000 selfies) taken around a city. The model may begin to associate faces with the location rather than learning from the intended permanent features of the city itself. In other words, the presence of faces becomes incorrectly linked to location identification, rather than the architectural and geographical features that actually define the location.

The non-limiting methods shown in these figures demonstrate how image analysis, automated prompt generation, and inpainting techniques can be combined in a multi-step process to prepare images for model training. First, image analysis techniques are applied to identify and isolate unwanted objects in the foreground of the image, such as people or vehicles that may create unwanted biases in the training data.

Next, the system automatically generates appropriate captions that focus on the permanent features of the scene, such as buildings, landscapes, or other distinctive architectural elements, while excluding the identified unwanted objects. These captions serve as guidance for the subsequent processing steps.

The system then removes the previously identified unwanted objects from the image. Following this removal, inpainting techniques are employed to reconstruct the scene in these areas, maintaining visual consistency with the surrounding image elements and preserving the important permanent features of the location.

Through this process, the system prepares cleaned images that are more suitable for model training, as they emphasize the permanent, identifying features of locations while removing potentially confusing or biasing elements. This systematic approach helps ensure that the trained model learns to identify locations based on their distinctive permanent characteristics rather than transient elements.

FIG. 10 shows an optional pre-processing method for images according to at least some embodiments. A CLIP Model Pre-Process Image Cleaning pipeline 1000 features a workflow for cleaning and preparing images before they enter the CLIP model training process. The process begins with an Original Image 1002, which serves as the input to the pipeline. Image 1002 is then analyzed by Computer Vision Object Detection 1004, which identifies and creates bounding boxes specifically for Person/Car/Truck and/or other objects in the image. Non-limiting examples of object detection methods include YOLO (You Only Look Once), Cascade R-CNN, EfficientDet, and SSD (Single Shot MultiBox Detector).

The bounding box information and image 1002 feed into a Generate Cleaned Caption (LLM) component 1006. Component 1006 ignores the identified bounding boxes and the material contained therein, and also excludes people, cars, and related objects from image 1002. From the remaining components of image 1002, component 1006 generates a caption focusing on the scenery and background elements and creates a description that emphasizes the permanent features of the location. The cleaned caption may be used as a prompt to replace the material contained in the bounding boxes.

To replace this material, image 1002 is preferably processed through a Clean Noise in Images process 1008 which receives the cleaned caption from component 1006, and using an inpainting process to replace the material that was removed from the bounding boxes according to the cleaned caption. Non-limiting examples of suitable algorithms for inpainting include StableDiffusion Inpainting, Fuse Fooocus SDXL inpainting, FLUX, or Epicrealism.

The cleaned caption and the inpainted image are then sent to OpenClip model training 1008, as training inputs. Without wishing to be limited by a closed list, the described process may be used for example to systematically remove transient objects (like people and vehicles) from images while preserving and emphasizing permanent location features, creating cleaner training data for the CLIP model. This process helps prevent the model from being biased by temporary or irrelevant objects in the scene.

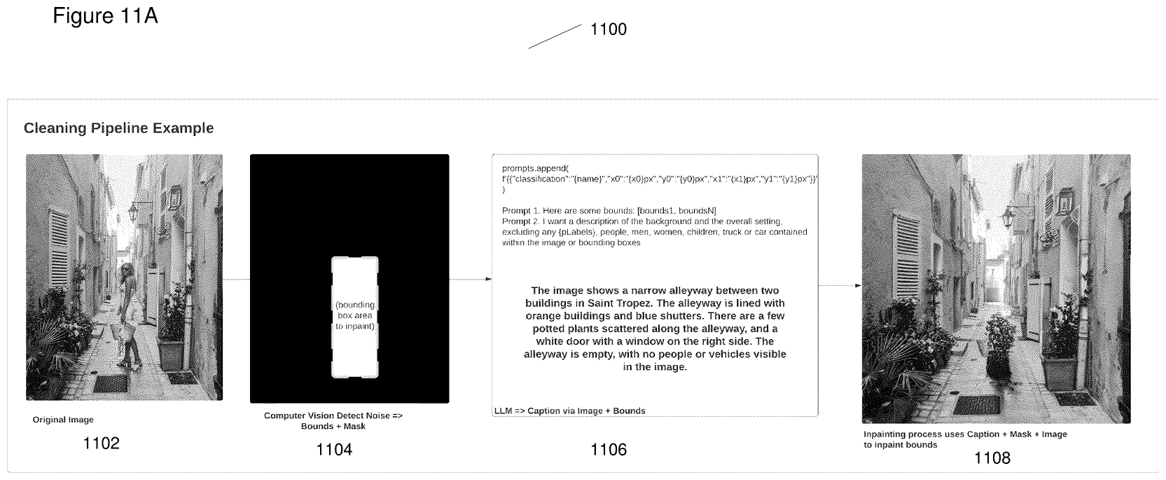

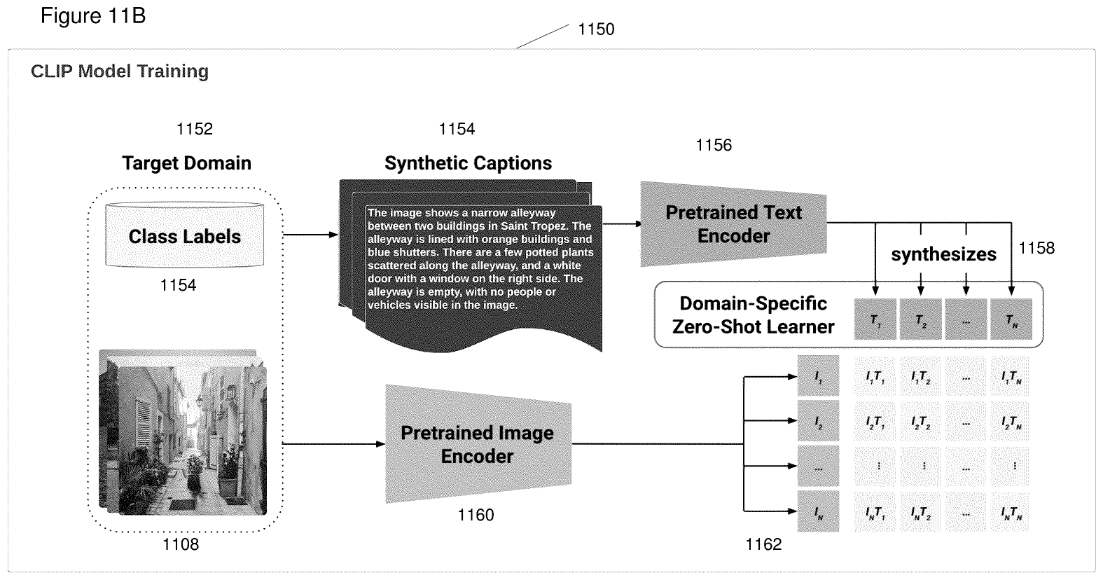

FIG. 11A shows an example of the pre-processing method for images. As shown, a cleaning pipeline 1100 demonstrates the process through multiple stages, beginning with an original image 1102, which in this non-limiting example shows a narrow alleyway with orange-colored buildings, blue shutters, and a person in the center foreground.

Image 1102 is then processed through a computer vision process 1104, which identifies the person in the image and creates a bounding box and mask specifically for that area. The bounding box is shown in yellow outline, indicating the region to be processed. As previously described, the bounding box is the area that will be “inpainted” (that is, filled in with material that does not include the transient object to be removed).

Image 1102 and the bounding box information are then processed by an LLM (Large Language Model) at 1106, which generates a caption based on the image while excluding the contents of the bounding box. In this non-limiting example, the caption describes: “The image shows a narrow alleyway between two buildings in Saint Tropez. The alleyway is lined with orange buildings and blue shutters. There are a few potted plants scattered along the alleyway, and a white door with a window on the right side. The alleyway is empty, with no people or vehicles visible in the image.” To create such a caption, one or more prompts are input as shown. A non-limiting example of such a prompt may include:

```
  for each bounding box,
  prompts_data.append(
f‘{{“classification”:“{name}”,“x0”:“{x0}px”,“y0”:“{y0}px”,“x1”:“{x1}px”,“y1”:“{y1}px”}}’
) [symbol]
  pLabels.append(label_name)
```

Prompt 1. Here are some bounds: [bounds1, boundsN] [symbol]
Prompt 2. I want a description of the background and the overall setting, excluding any {pLabels}, people, men, women, children, truck or car contained within the image or bounding boxes.

The bounds provide X and Y coordinates which may be formatted as:
1. Top, left, width, height of box
2. Center X, center Y, width, height of box
3. top left (x0,y0), bottom right (x1,y1) static box positions

These values may either be a floating point value relative to the size of the image, or as a static pixel value as in the example above.

At 1108, an inpainting process uses the output caption and the mask to inpaint (replace) the bounded area within image 1102. The output image shows the same alleyway scene but with the person removed and replaced with a continuation of the alleyway and its features, removing the transient object (person). Of course, this method may be employed for removal of a wide variety of different types of objects, whether transient or non-transient.

This non-limiting example demonstrates how the cleaning pipeline can effectively remove transient elements (in this case, a person) while preserving and maintaining the permanent architectural and scenic features of the location, thereby creating more suitable training data for location identification purposes.

FIG. 11B shows an optional method for training with processed images, according to at least some embodiments. A CLIP model training process 1150 according to at least some embodiments is shown, illustrating how the cleaned images and captions are used to train the model. The process begins with a target domain 1152, which contains class labels 1154 and the cleaned image 1108 from the previous cleaning pipeline (FIG. 11A).

The class labels 1154 and cleaned image 1108 are processed to generate synthetic captions 1154. In this non-limiting example, the synthetic caption contains the same text that was generated by the LLM in FIG. 11A, describing the alleyway in Saint Tropez without reference to any transient objects.

The synthetic captions are input to a pretrained text encoder 1156, which synthesizes 1158 the text into a format suitable for training. This synthesis produces Domain-Specific Zero-Shot Learner outputs, shown as T₁, T₂, . . . T_{N}.

Simultaneously, the cleaned image 1108 is processed through a pretrained image encoder 1160, which generates image embeddings. These embeddings are combined with the synthesized text outputs in a matrix 1162, showing the relationships between images (I₁, I₂, . . . IN) and the synthesized text outputs (T₁, T₂, . . . . TN).

Without wishing to be limited in any way, this exemplary process demonstrates how the cleaned images and their corresponding synthetic captions are encoded and combined to create training data that focuses on permanent location features rather than transient objects, thereby improving the model's ability to identify locations based on their permanent characteristics.

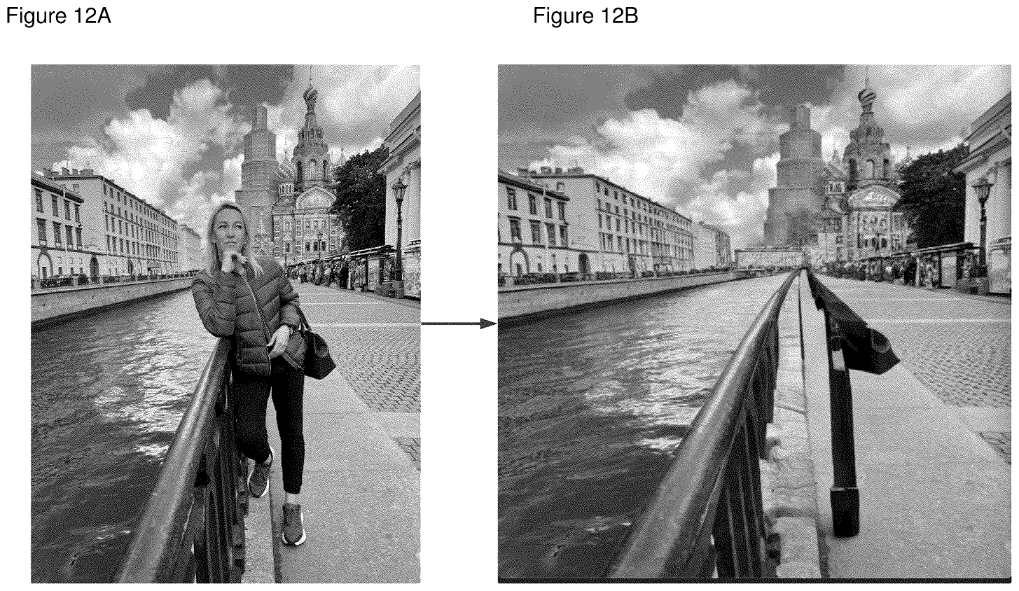

FIG. 12A shows an illustrative image before processing, while FIG. 12B shows the image after processing. FIG. 12A shows an illustrative image before processing, featuring a tourist location in Eurasia. The image contains a person in a brown winter coat standing against a railing in the foreground, with a distinctive church featuring ornate architecture, multiple spires, and a distinctive tower visible in the background. The scene also includes cobblestones in the foreground and additional buildings along the side.

FIG. 12B shows the same image after processing through the pipeline described previously. The person has been removed through the inpainting process, and the railing and waterfront area continue uninterrupted across the formerly occupied space. The permanent architectural features-including the distinctive church, spires, tower, cobblestones, and surrounding buildings-remain unchanged.

This pair of images demonstrates how the processing pipeline effectively removes transient elements (in this case, a person) while maintaining the integrity of the permanent location-identifying features that are valuable for training the location identification model. By removing transient elements that could potentially bias or confuse the model's location identification capabilities before training, the trained model is much more likely to be able to correctly identify a location. Again, other types of objects (transient or non-transient) may be removed through this process, according to the goal of training the image model.

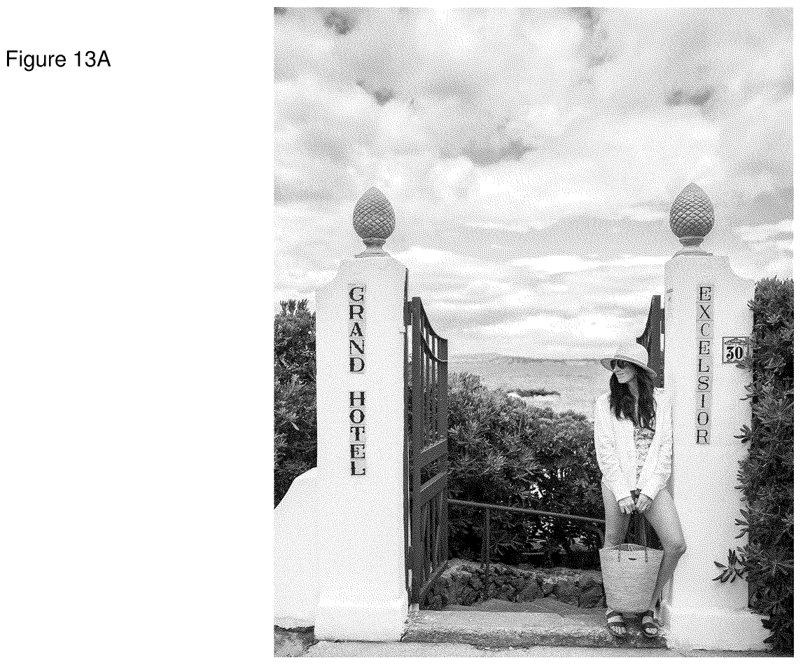

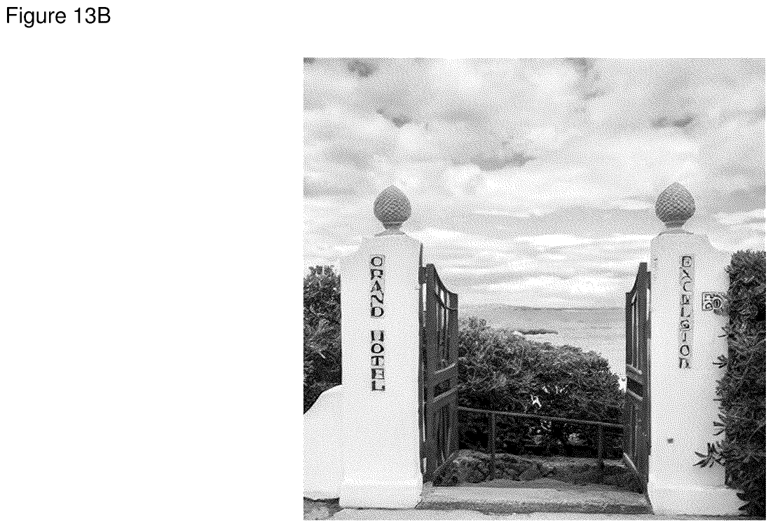

FIGS. 13A-16B show pairs of images before processing (FIGS. 13A, 14A, 15A and 16A) and after processing (FIGS. 13B, 14B, 15B and 16B). FIGS. 13A and 13B show a location at a hotel entrance. FIG. 13A features a person in vacation attire standing at an entrance marked by distinctive white pillars with yellow lettering reading “GRAND HOTEL” and “EXCELSIOR”, with decorative pineapple finials atop the pillars and a blue gate. FIG. 13B shows the same location with the person removed through inpainting, preserving the distinctive architectural features including the pillars, lettering, gate and oceanfront vista in the background.

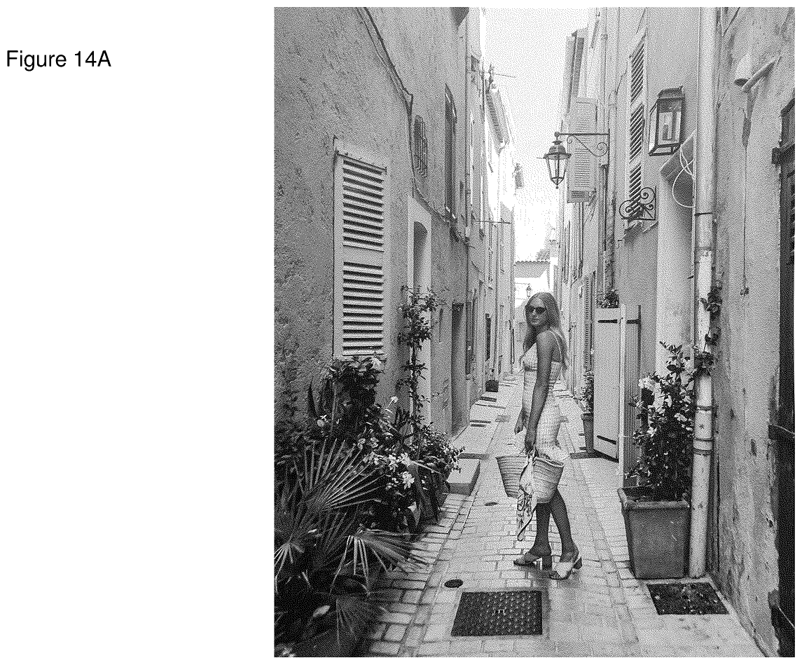

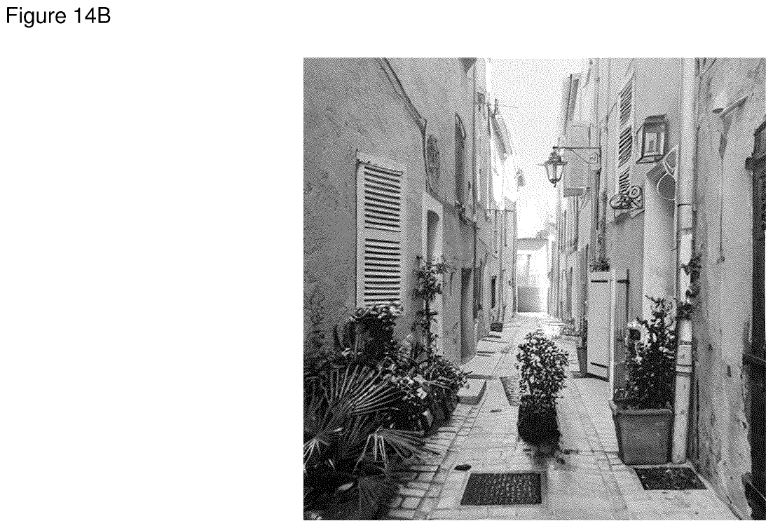

FIGS. 14A and 14B show a narrow European alleyway. FIG. 14A includes a person in the scene wearing a striped dress and carrying a basket, with distinctive orange-colored walls, blue shutters and potted plants along the sides. FIG. 14B shows the same alleyway with the person removed and the cobblestone path, walls, shutters and plants seamlessly continued through the inpainted area.

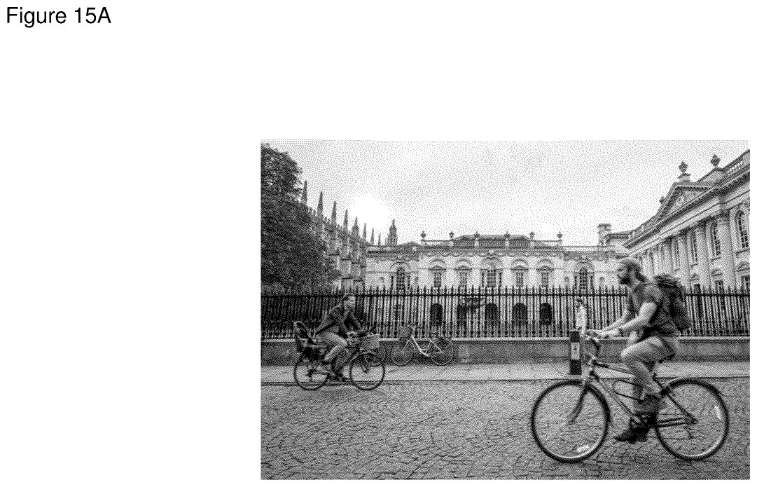

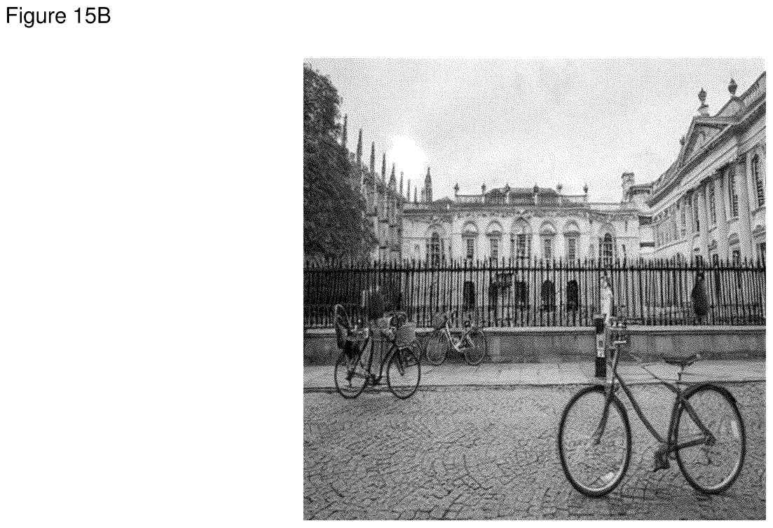

FIGS. 15A and 15B show an elegant historic building. FIG. 15A includes cyclists in motion in front of ornate Gothic architecture featuring spires and decorative stonework behind iron railings. FIG. 15B shows the same architectural scene with the cyclists removed, maintaining the building's distinctive features and ground textures by inpainting.

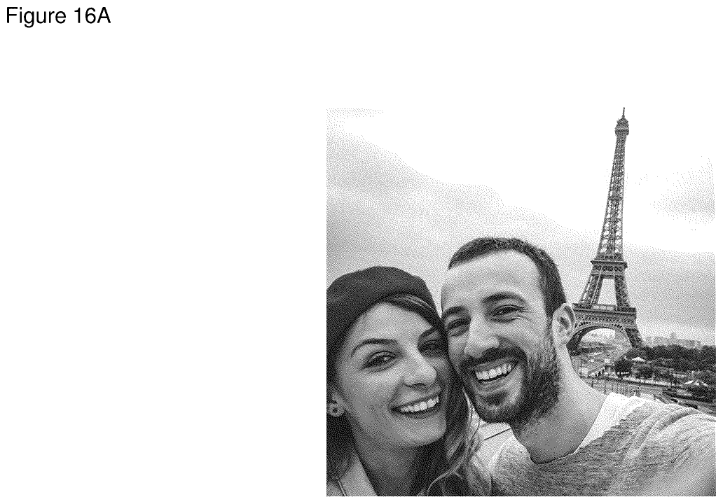

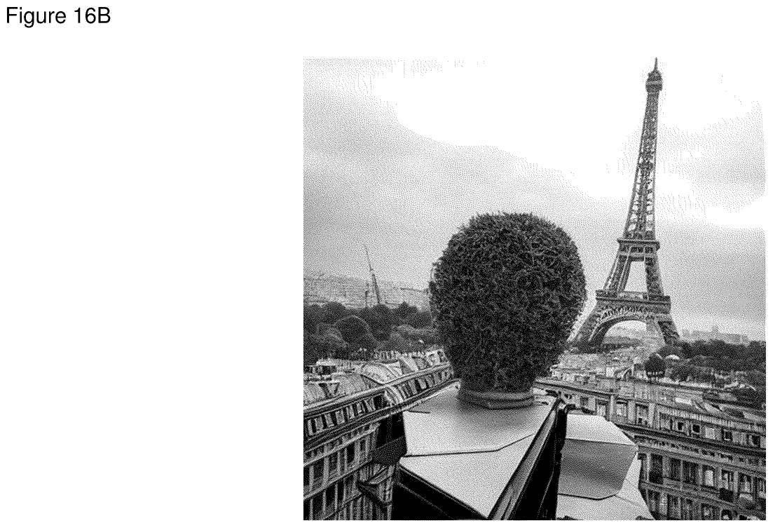

FIGS. 16A and 16B show the Eiffel Tower in Paris. FIG. 16A contains people in the foreground taking a selfie-style photograph, while FIG. 16B shows the same view with the people removed and the architectural features and cityscape preserved through the inpainting process.

Without wishing to be limited in any way, these pairs of images demonstrate the versatility and effectiveness of the cleaning pipeline across various types of locations, consistently removing transient elements while preserving the permanent architectural and geographic features that are valuable for location identification training.

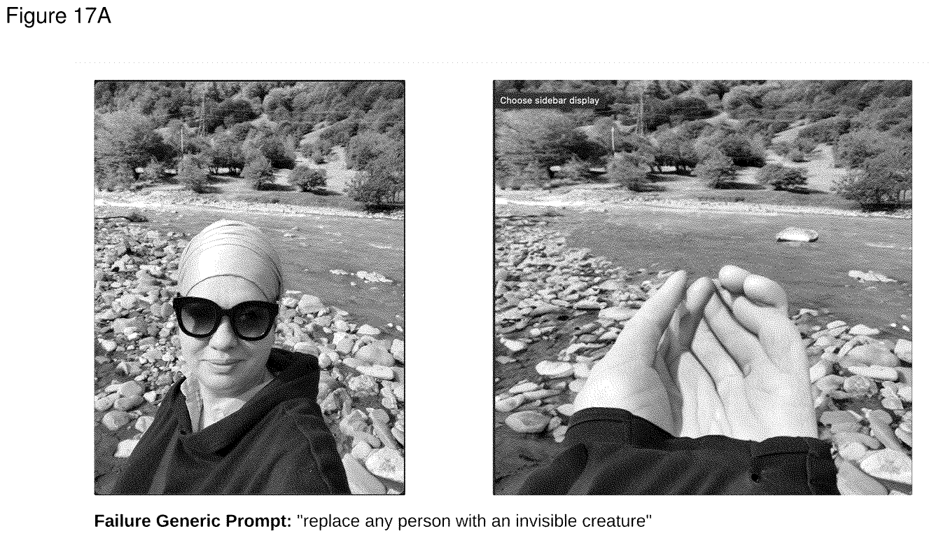

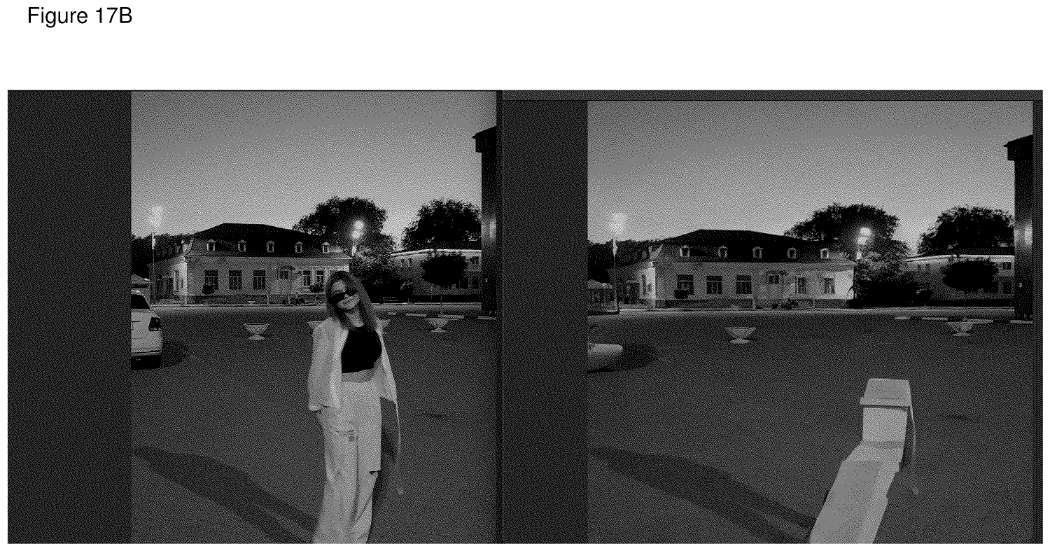

FIGS. 17A and 17B show illustrative errors caused by incorrect prompt engineering. FIG. 17A shows an example labeled “Failure Generic Prompt”, where the prompt “replace any person with an invisible creature” was used. Two images are shown—the original image with a woman wearing a head covering and sunglasses sitting by a rocky riverbank, and the processed image where the person has been replaced with disembodied hands. This inappropriate replacement demonstrates how a non-specific or incorrectly formulated prompt can lead to unrealistic or unusable results.

FIG. 17B shows another example of a prompt engineering failure. The original image shows a person in light-colored clothing and sunglasses standing in an urban setting in low light, with buildings visible in the background (left). The processed image at the right shows an attempt at inpainting, that has resulted in an inappropriate geometric shape roughly matching the person's outfit colors but failing to blend naturally with the scene. This artifact illustrates how inadequate prompt engineering can lead to artifacts and unrealistic scene reconstruction.

The present disclosure is described above with reference to block diagrams and flowchart illustrations of method and system embodying the present disclosure. It will be understood that various blocks of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, as shown herein. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application/or implementation without departing from the spirit or scope of the disclosure.

What is claimed is:

1. A method for location-based image analysis, comprising:
receiving an image to be analyzed by a computational device, said computational device comprising a memory for storing instructions and a processor for executing said instructions, wherein said instructions comprise instructions for:
extracting features from the received image using an image embedding model to generate image embeddings;
determining a relevance of the received image based on a comparison of the image embeddings with a trained image comparison model, wherein the trained image comparison model is selected from the group consisting of an autoencoder and an anomaly detection model;
comparing the received image to a plurality of images with known locations using an Approximate Nearest Neighbor (ANN) search tree model if the received image is determined to be relevant; and
identifying a location associated with the received image based on the comparison with the plurality of images with known locations.

2. The method of claim 1, wherein said image embedding model is selected from the group consisting of a Contrastive Language-Image Pre-training (CLIP), ResNet, VGG (Visual Geometry Group) model variants, EfficientNet models and ViT.

3. The method of claim 2, wherein said trained image comparison model comprises said anomaly detection model, and wherein said anomaly detection model is selected from the group consisting of an IsolationForest algorithm, One-Class SVM (Support Vector Machine), Local Outlier Factor (LOF); DBSCAN (Density-Based Spatial Clustering of Applications with Noise); and K-Means Clustering.

4. The method of claim 3, wherein said anomaly detection model determines a similarity of said received image to a plurality of comparison images according to a similarity measure, wherein if said similarity is above a first threshold, indicating a positive similarity match, said received image is passed to said ANN search tree model; and if said similarity is not above said first threshold, said received image is not passed to said ANN search tree model.

5. The method of claim 4, wherein said anomaly detection model comprises said IsolationForest algorithm.

6. The method of claim 1, wherein the trained image comparison model comprises an autoencoder, and the relevance of the received image is determined based on a mean squared error (MSE) score; wherein if said MSE score is below a first threshold, indicating a positive similarity match, said received image is passed to said ANN search tree model; and if said similarity is not below said first threshold, said received image is not passed to said ANN search tree model.

7. The method of claim 6, wherein the ANN search tree model utilizes an index created from the image embeddings, and the index is optimized based on selected parameters for index construction.

8. The method of claim 7, wherein said instructions further comprise instructions for:
applying a second threshold to the comparison output from the ANN search tree model to determine if the received image is associated with a location of interest.

9. The method of claim 8, wherein said second threshold is determined based on a distance output from the ANN search tree model, and the distance represents an angular distance between normalized feature vectors of the received image and the plurality of images with known locations.

10. A system for location-based image analysis, comprising:
(a) a user computational device configured to receive an image to be analyzed;
(b) an analysis engine communicatively coupled to the user computational device, the analysis engine configured to:
extract features from the received image using an image embedding model to generate image embeddings;
determine a relevance of the received image based on a comparison of the image embeddings with a trained image comparison model, wherein the trained image comparison model is selected from the group consisting of an autoencoder and an anomaly detection model;
compare the received image to a plurality of images with known locations using an Approximate Nearest Neighbor (ANN) search tree model if the received image is determined to be relevant; and
identify a location associated with the received image based on the comparison with the plurality of images with known locations.
(c) a memory for storing the image embeddings, the instructions for executing the analysis engine, and the trained model; and
(d) a processor configured to execute instructions for executing the analysis engine.

11. The system of claim 10, wherein said image embedding model is selected from the group consisting of a Contrastive Language-Image Pre-training (CLIP), ResNet, VGG (Visual Geometry Group) model variants, EfficientNet models and ViT.

12. The system of claim 10 or 11, wherein said trained image comparison model comprises said anomaly detection model, and wherein said anomaly detection model is selected from the group consisting of an IsolationForest algorithm, One-Class SVM (Support Vector Machine), Local Outlier Factor (LOF); DBSCAN (Density-Based Spatial Clustering of Applications with Noise); and K-Means Clustering.

13. The system of claim 12, wherein said anomaly detection model determines a similarity of said received image to a plurality of comparison images according to a similarity measure, wherein if said similarity is below a first threshold, indicating a positive similarity match, said received image is passed to said ANN search tree model; and if said similarity is not below said first threshold, said received image is not passed to said ANN search tree model.

14. The system of claim 12 or 13, wherein said anomaly detection model comprises said IsolationForest algorithm.

15. The system of any of the above claims, wherein the trained image comparison model comprises an autoencoder, and the relevance of the received image is determined based on a mean squared error (MSE) score; wherein if said MSE score is below a first threshold, indicating a positive similarity match, said received image is passed to said ANN search tree model; and if said similarity is not below said first threshold, said received image is not passed to said ANN search tree model.

16. The system of any of the above claims, wherein the ANN search tree model utilizes an index created from the image embeddings, and the index is optimized based on selected parameters for index construction.

17. The system of any of the above claims, wherein said instructions further comprise instructions for:
applying a second threshold to the comparison output from the ANN search tree model to determine if the received image is associated with a location of interest.

18. The system of claim 17, wherein said second threshold is determined based on a distance output from the ANN search tree model, and the distance represents an angular distance between normalized feature vectors of the received image and the plurality of images with known locations.

19. A method for preparing images for location-based image analysis, comprising:
receiving an original image by a computational device, said computational device comprising a memory for storing instructions and a processor for executing said instructions, wherein said instructions comprise instructions for:
analyzing the original image using computer vision object detection to identify and create bounding boxes for specific objects in the image;
generating a cleaned caption for the original image using a large language model, wherein the cleaned caption excludes references to objects within the identified bounding boxes;
performing an inpainting process on the original image to replace content within the bounding boxes based on the cleaned caption, resulting in a cleaned image; and
providing the cleaned image and the cleaned caption as inputs for training a location identification model.

20. The method of claim 19, wherein the specific objects identified for removal include transient objects selected from the group consisting of people, vehicles, and temporary structures.

21. The method of claim 19, further comprising:
generating synthetic captions for the cleaned image based on class labels associated with the original image;
processing the synthetic captions through a pretrained text encoder to produce text embeddings;
processing the cleaned image through a pretrained image encoder to produce image embeddings; and
combining the text embeddings and image embeddings to create training data for the location identification model.

22. The method of claim 19, wherein the large language model used for generating the cleaned caption is provided with prompts that include bounding box coordinates for the identified objects and instructions to exclude specific types of objects from the caption.

23. The method of claim 19, wherein the inpainting process utilizes an algorithm selected from the group consisting of StableDiffusion Inpainting, Fuse Fooocus SDXL inpainting, FLUX, and Epicrealism.
